(19) United States
(12) Patent Application Publication
(10) Pub. No.: US 2010/0159612 A1
(43) Pub. Date: Jun. 24, 2010

(54) SENSOR CHIP AND METHOD FOR USE THEREOF

(75) Inventor: Shizuko ONO, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/640,499

(22) Filed: Dec. 17, 2009

(30) Foreign Application Priority Data
Dec. 24, 2008 (JP) 2008-327819

(51) Int. Cl. G01N 21/75; G01N 21/01

(52) U.S. Cl. 436/164; 422/82.05

(57) ABSTRACT

A sensor chip has: a light transmitting outer package, a plurality of reaction chambers disposed inside the outer package; a plurality of first induction paths that are connected to the reaction chambers and introduce a sample liquid into the reaction chambers; a first induction path where the induction paths merge; an introducing portion that is connected to the induction path and introduces the sample liquid; second induction paths that are connected to the reaction chambers respectively; a second induction path where the induction paths merge, and a cavity portion constituting a suction portion that is connected to the induction path and sucks the sample liquid. The total lengths of the first induction paths that are connected to different reaction chambers are different from each other, and different types of test reagents are held in the plurality of reaction chambers respectively.

### BACKGROUND OF THE INVENTION

1. Field of the Invention

The present invention relates to a sensor chip and a method for using this sensor chip.

2. Related Background Art

As a method for evaluating the characteristics of the sample liquid, a method for contacting the sample liquid and test reagent for causing a reaction and evaluating the characteristics based on the reaction result has been used. If the sample liquid is human saliva, for example, the simplest method could be to contact the sample liquid and test reagent by inserting a test paper, on which the test reagent is adhered, into the oral cavity. With this method, however, the test reagent may be taken into the body by the test reagent being dissolved from the test paper in the oral cavity. Therefore various measurement instruments to simply and safely evaluate the characteristics of the saliva in the oral cavity have been studied (e.g. see Japanese Patent Application Laid-Open No. 2006-184142).

### SUMMARY OF THE INVENTION

In the case of evaluating the state of health in the oral cavity by evaluating the characteristics of saliva as the sample liquid, a plurality of types of test reagents is often used for measurement so that the results are totally evaluated. The test reagents combined and used for evaluation in this case may have different reaction times. However if a measurement is performed with a plurality of test reagents using a measurement instrument according to Japanese Patent Application Laid-Open No. 2006-184142, the times when the sample liquid reaches the areas where the test reagents are carried would be the same. In the case of some test reagents, the reaction result may not be evaluated correctly if the reaction time is exceeded, due to the generation of discoloration, for example. Hence in order to accurately evaluate reactions by test reagents having different reaction times, the reaction result must be checked every time the respective reaction time elapses, which increases the operation volume time. If the reaction results of a plurality of types of test reagents are checked all at once, on the other hand, the result cannot be evaluated accurately.

With the foregoing in view, it is an object of the present invention to provide a sensor chip that can easily and accurately evaluate sample liquid using a plurality of test reagents and a method for using this sensor chip.

To achieve the above object, a sensor chip according to one aspect of the present invention comprises: an outer package; a plurality of reaction chambers disposed inside the outer package; a plurality of first induction paths that are connected to the plurality of reaction chambers and introduce a sample liquid into the plurality of reaction chambers respectively; an introducing portion that is connected to the first induction paths and introduces the sample liquid into the first induction paths; a plurality of second induction paths that are connected to the plurality of reaction chambers respectively; and a suction portion that is connected to the plurality of second induction paths and sucks the sample liquid flowing in the plurality of second induction paths, wherein the outer package has a light transmitting entrance portion for light to enter into the reaction chambers, and a light transmitting emission portion for light to emit from the reaction chambers, the plurality of first induction paths have different lengths from one another, and different types of test reagents are held in the plurality of reaction chambers respectively.

According to the above mentioned sensor chip, the sample liquid is introduced from the introducing portion by the suction of the suction portion, and is sent to a plurality of reaction chambers that hold the test reagents via the first induction paths, and the test reagent and the sample liquid react in the plurality of reaction chambers. The time required for the sample liquid introduced to the introducing portion to reach the reaction chamber differs depending on the reaction chamber, since the lengths of the plurality of first induction paths connecting the introducing portion to introduce the sample liquid and the plurality of reaction chambers holding the test reagent are different from one another. Therefore if test reagents having different reaction times are used for measurement, an test reagents having a long reaction time is held by a reaction chamber of which the length of a first induction path is short, for example, and an test reagent having a short reaction time is held by a reaction chamber of which the length of a first induction path is long, then the time when the reaction of the sample liquid and each test reagent completes can be similar. As a result, the reaction results by a plurality of types of test reagents can be checked all at once, and evaluation of sample liquid using a plurality of test reagents can be performed more easily and accurately.

Here it is preferable that the cross-section areas of the plurality of first induction paths are different from one another. If the cross-section areas of the first induction paths are different from one another in this way, it is easy to adjust the times when the sample liquid reaches the plurality of reaction chambers, and the time when the reaction by each of the plurality of test reagents completes can be closer, so the sample liquid can be evaluated at higher accuracy.

It is preferable that the introducing portion is sealed by the outer package and is opened for use. By using this configuration, deterioration of the test reagent held in the reaction chambers in the outer package caused by contact with outside air, such as due to oxidation, can be prevented, and the sample liquid can be evaluated more accurately.

It is preferable that fibrous material is filled in the plurality of reaction chambers. By filling the fibrous material in a reaction chamber, micro spaces are formed by the fibers included in the fibrous material in the reaction chamber, and the sample liquid is held by these micro spaces, whereby micro cells are constituted. Therefore light that transmits through the fibrous material via the micro cells can be increased, and evaluation of the sample liquid using the optical system can be executed more accurately.

It is preferable that the test reagent is carried by the fibrous material. If the test reagent is carried by the fibrous material, and the sample liquid is held by this fibrous material, the test reagent and the sample liquid are appropriately dispersed and reacted in the micro cells formed by the fibers of the fibrous material, so measurement dispersion depending on the measurement location is decreased, and the sample liquid can be evaluated at higher accuracy.

The plurality of second induction paths may merge with one another between the plurality of reaction chambers and the suction portion. By allowing the second induction paths merge between the reaction chambers and the suction portion, the suction force by the suction portion for the plurality of induction paths can be equalized. Therefore the completion time of a reaction in each of the plurality of reaction chambers can be adjusted more accurately.

The suction portion may have a space sealed by the outer package, and suck the sample liquid by increasing the volume of the space during use.

The suction portion may have a pump mechanism, and sucks the sample liquid by the pump mechanism operating during use.

A cross-section area of the second induction path that is connected to one reaction chamber included in the plurality of reaction chambers can be smaller than a cross-section area of the first induction path that is connected to this one reaction chamber. In this case, suction pressure by the suction portion can be increased by making the cross-section area of the second induction path, out of the first induction path and the second induction path, smaller than the first induction path, and the sample liquid can be sucked more smoothly.

The method for using a sensor chip according to one aspect of the present invention uses a sensor chip which has: a light transmitting outer package; a plurality of reaction chambers disposed inside the outer package; a plurality of first induction paths that are connected to the plurality of reaction chambers and introduce a sample liquid into the plurality of reaction chambers respectively; an introducing portion that is connected to the first induction paths and introduces the sample liquid into the first induction paths; a plurality of second induction paths that are connected to the plurality of reaction chambers respectively; and a suction portion that is connected to the plurality of second induction paths and sucks the sample liquid flowing in the plurality of second induction paths, the outer package having a light transmitting entrance portion for light to enter into the reaction chambers, and a light transmitting emission portion for light to emit from the reaction chambers, the method including introducing the sample liquid into the plurality of reaction chambers by opening the introducing portion of the outer package for the sample liquid to contact the introducing portion and by sucking the sample liquid using the suction portion, to thereby react the sample liquid and the test reagent, wherein a time from the sample liquid contacting the introducing portion to the sample liquid being introduced into the reaction chamber is different for each of the plurality of reaction chambers.

A sensor chip and a method for using this sensor chip, which allows to evaluate the sample liquid using the plurality of test reagents more easily can be provided.

### BRIEF DESCRIPTION OF THE DRAWINGS

FIG. 1 is a front view depicting a sensor chip according to a first embodiment of the present invention;

FIG. 2A is a cross-sectional view of IIA-IIA in FIG. 1;

FIG. 2B is a cross-sectional view of IIB-IIB in FIG. 1;

FIG. 3 is a diagram depicting a method for using the sensor chip according to the first embodiment;

FIG. 4 is an exploded perspective view of FIG. 1;

FIG. 5 is an exploded perspective view of a variant form of the sensor chip of the first embodiment;

FIG. 6 is a diagram depicting a general configuration of a liquid measurement device according to the first embodiment;

FIG. 7 is a diagram depicting a positional relationship of a light source and a light receiving portion in the liquid measurement device according to the first embodiment;

FIG. 8 is a diagram depicting a variant form of the positional relationship of the light source and the light receiving portion of the liquid measurement device according to the first embodiment;

FIG. 9 is a flow chart depicting a method for measuring sample liquid using the liquid measurement device and the sensor chip;

FIG. 10 is a front view depicting a sensor chip according to the second embodiment of the present invention;

FIG. 11A is a cross-sectional view of XIA-XIA in FIG. 10;

FIG. 11B is a cross-sectional view of XIB-XIB in FIG. 10;

FIG. 12 is an exploded perspective view of FIG. 10;

FIGS. 13A, 13B are diagrams depicting a method for using the sensor chip according to the second embodiment;

FIGS. 14A, 14B are cross-sectional views depicting a part of a general configuration of the liquid measurement device according to the second embodiment; and

FIG. 15 is a cross-sectional view depicting a variant form of a general configuration of the liquid measurement device according to the second embodiment.

### DESCRIPTION OF THE PREFERRED EMBODIMENTS

Embodiments of the present invention will now be described with reference to the accompanying drawings. The same composing elements in the drawings are denoted with a same reference symbol, where redundant description is omitted.

### First Embodiment

### Sensor Chip

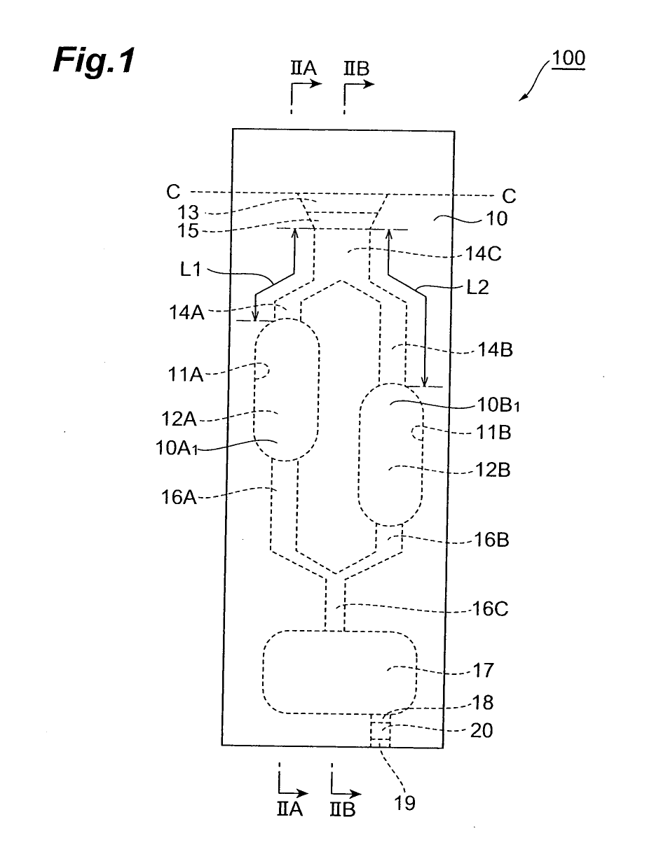

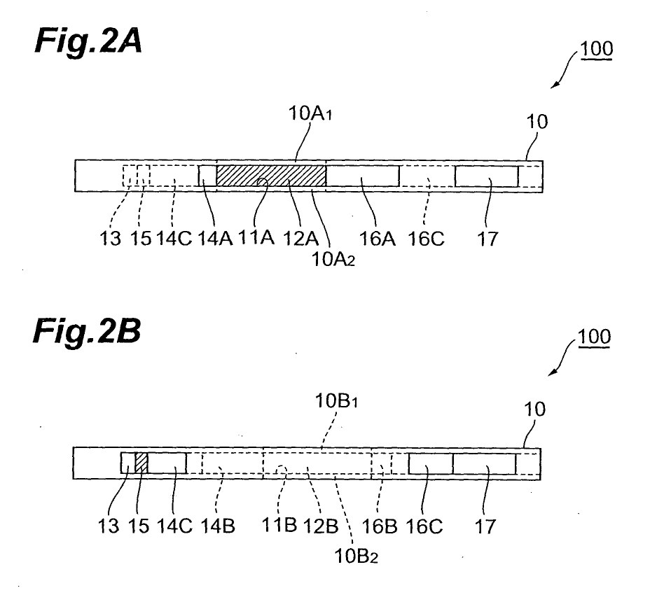

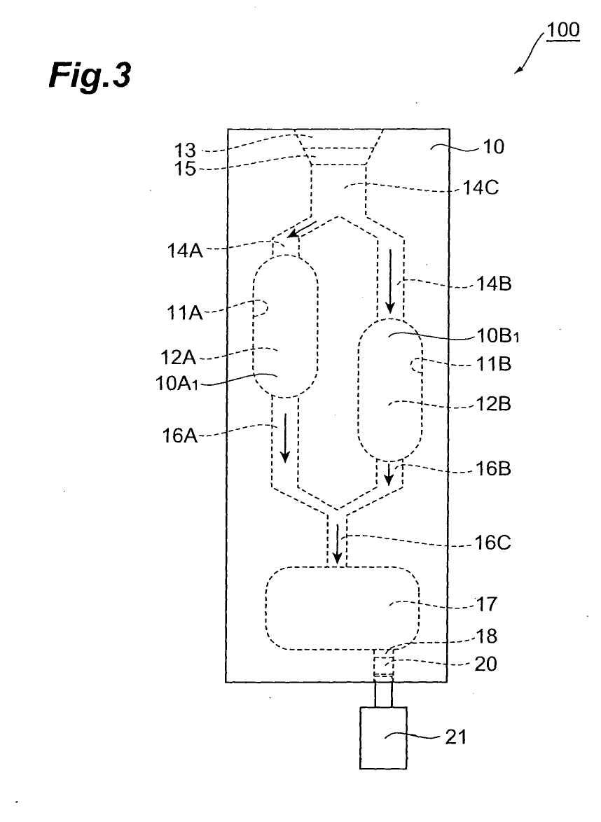

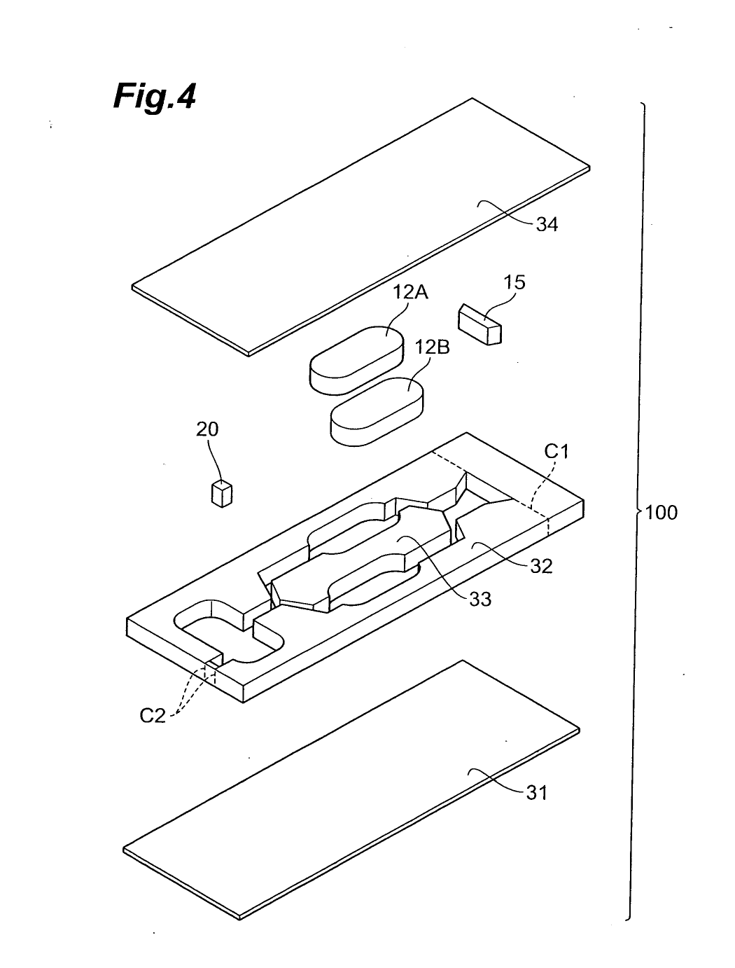

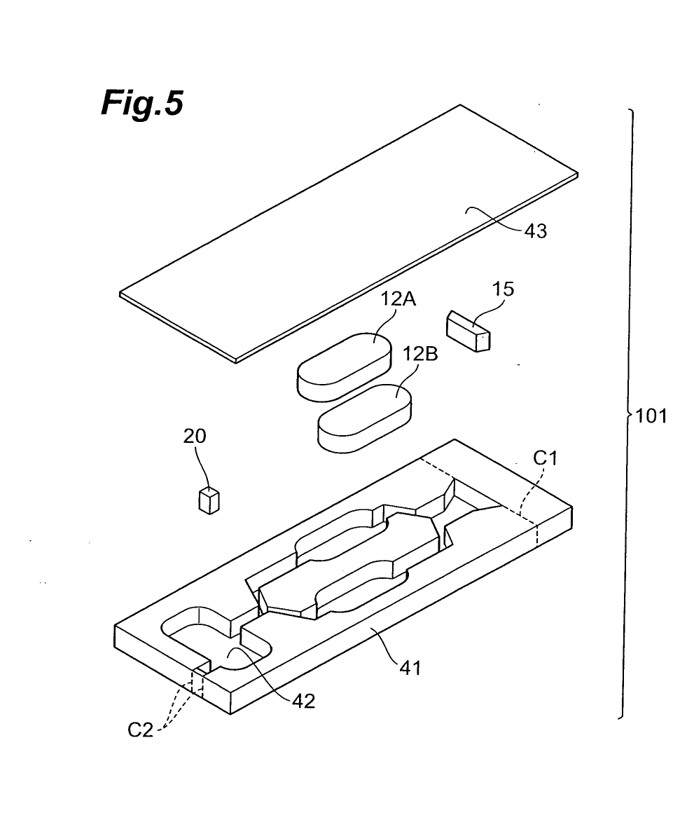

FIG. 1 is a front view depicting a sensor chip 100 according to a first embodiment of the present invention, FIG. 2A is a cross-sectional view of IIA-IIA in FIG. 1, FIG. 2B is a cross-sectional view of IIB-IIB in FIG. 1, FIG. 3 is a diagram depicting a method for using the sensor chip 100, FIG. 4 is an exploded perspective view of FIG. 1, and FIG. 5 is an exploded perspective view of a sensor chip 101, which is a variant form of the sensor chip 100 of the present embodiment. The sensor chip according to the first embodiment of the present invention will now be described with reference to these drawings.

As FIG. 1 and FIG. 2 shows, the sensor chip 100 according to the present embodiment, has a light transmitting outer package 10, a plurality of reaction chambers 11A and 11B which are disposed inside the outer package 10, and fibrous materials 12A and 12B which are contained in the reaction chambers IIA and IIB respectively. To the reaction chambers 11A and 11B, induction paths 14A and 14B, which are first induction paths for introducing sample liquid respectively, are connected, and an induction path (first induction path) 14C, where these induction paths 14A and 14B are merged, is also connected. To the induction path 14C, an introducing portion 13 is connected via a filter 15. In opposite positions of the induction paths 14A and 14B (lower portion in FIG. 1), induction paths 16A and 16B, which are second induction paths, are connected to the reaction chambers 11A and 11B respectively, and these induction paths 16A and 16B merge in an induction path (second induction path) 16C there under. A cavity portion 17 which is connected to the induction path 16C and constitutes a suction portion, a suction port 18 which connects this cavity portion 17 and outside the sensor chip 100 via a filter 20, and an insertion port 19, are also disposed.

Sample liquid, to be the test target, is adhered to the fibrous materials 12A and 12B of the sensor chip 100 having the above configuration, and is held in a later mentioned liquid measurement device, and this sample liquid is measured by irradiating measurement lights respectively onto the fibrous materials 12A and 12B in which the sample liquid adheres. Considering ease of handling, measuring small amounts of sample liquid and accurate measurement, the sensor chip 100 is preferably a rectangular sheet. The size of the sensor chip 100 is not particularly limited, but preferably is a size with which the sensor chip 100 can be easily handled, such as thickness: 0.1 mm to 5.0 mm, length of long side: 5 mm to 150 mm, and length of short side: 5 mm to 100 mm.

In an area contacting the reaction chamber 11A, out of the outer package 10, a light transmitting entrance portion 10A₁ and a light transmitting emission portion 10A₂ are disposed. The entrance portion 10A₁ is a light transmitting area which lets light enter to the reaction chamber 11A, and the emission portion 10A₂ is a light transmitting area which lets light emit from the reaction chamber 11A. By disposing these areas, measurement light can be irradiated onto the fibrous material 12A which the sample liquid adheres to and is held in the reaction chamber 11A, and light, which is emitted from the sample liquid (transmitted light or reflected light) by irradiating the measurement light onto the sample liquid, can be emitted to the outside. A light transmitting entrance portion 10B₁ and a light transmitting emission portion 10B₂ are also disposed in an area contacting the reaction chamber 11B.

The arrangement of the entrance portions and emission portions is appropriately changed depending on the type of the light which is used for liquid measurement. If the transmitted light emitted from the sample liquid is used for liquid measurement, for example, the entrance portion 10A₁ and the emission portion 10A₂ are disposed facing the reaction chamber 11A in which the fibrous material 12A is contained as shown in FIG. 2A. If the reflected light emitted from the sample liquid is used for liquid measurement, the entrance portion 10A₁, which also functions as the emission portion 10A₂, can be disposed on one surface of the reaction chamber 11A in which the fibrous material 12A is contained. The sizes of the entrance portions 10A₁ and 10B₁ and the emission portions 10A₂ and 10B₂ can be appropriately changed according to the entrance aperture of the light used for the liquid measurement and light receiving capability of the liquid measurement device.

In the entrance portions 10A₁ and 10B₁ and the emission portions 10A₂ and 10B₂, which are disposed in areas contacting the reaction chambers 11A and 11B, out of the outer package 10, it is preferable that light transmittance at the wavelength of the measurement light that is irradiated during liquid measurement is 70% or more. If the material of which light transmittance is within the above mentioned range is used for the entrance portions and the emission portions of the outer package 10, the measurement light can be appropriately irradiated onto the sample liquid adhering to the fibrous materials 12A and 12B, and the light transmitted from the fibrous materials 12A and 12B can be emitted from the sensor chip 100 without attenuating the light quantity.

A possible material of the outer package 10 is a laminate film of polyethylene, polypropylene, polyethylene terephthalate, polyvinyl chloride, polyvinylidene chloride, polyvinyl alcohol, polyester, polycarbonate, polystyrene, polyacrylonitrile or nylon (registered trademark), or glass, but in terms of stability and accuracy of pH, it is preferable to select a material which has resistance to the sample liquid. In terms of measurement accuracy, it is preferable to select a material of which light transmittance does not drop by whitening due to thermal fusion when the outer package 10 is structured. The outer package 10 may be constructed by selecting a plurality of types of the above mentioned materials. For example, a glass plate can be used for only one surface of the fibrous materials 12A and 12B so that strength of the sensor chip 100 is maintained. A gas barrier prevention film, for example, may be disposed outside the outer package 10. According to the present embodiment, the entire body of the outer package 10 is light transmitting, but only the area to be the entrance portions and emitting portions, out of the outer package 10, may be light transmitting, and the other area non-transmitting.

Now the fibrous materials 12A and 12B placed in the reaction chambers 11A and 11B disposed inside the sensor chip 100 will be described next. The water absorbency of the fibrous materials 12A and 12B, measured according to JIS P8140, is preferably 6.0 cm to 30.0 cm (more preferably 7.0 to 20.0 cm). If the water absorbency is in the above mentioned range, the sample liquid can be appropriately adhered to the fibrous materials 12A and 12B, even if the sample liquid has viscosity, as in the case of saliva. The water absorbency is actually measured by preparing a test piece of which width is 15±1 mm and length is 200 mm or more, vertically dipping the bottom end thereof into 23±1° C. of water for ten minutes, and measuring the height that rises by the capillaries of the test piece.

The fiber diameter of the fibrous materials 12A and 12B is preferably 0.001 μm to 500 μm (more preferably 0.01 μm to 100 μm), and the void ratio of preferably 20% to 99% (more preferably 50% to 99%). If the fiber diameter and the void ratio are in the above mentioned range, the sample liquid can be appropriately adhered inside the fibrous materials 12A and 12B, so accuracy of the measurement result can be increased. The void ratio is measured by detecting the mercury infiltration in the pores of a sample of the fibrous material using a porosimeter.

A material that can be appropriately used for the fibrous materials 12A and 12B is, for example, filter paper, membrane, filter plate and a glass-mixed filter paper. Among these, filter paper, which is stable in a pH 0 to 12 range and has superb water absorbency, can be appropriately used. If the filter paper is used for the fibrous materials 12A and 12B, in which the sample liquid is adhered and which has an appropriate light transmittance, the water absorbency of the fibrous materials 12A and 12B improves, and stability of the reaction of the test reagent and sample liquid improves, therefore the results of the reaction by the test reagent can be accurately measured. If a membrane is used for the fibrous materials 12A and 12B, a cellulose type (nitro cellulose) is appropriate for use as the material of the membrane.

The reaction chambers 11A and 11B in which the fibrous materials 12A and 12B are contained are connected to the introducing portion 13, that introduces the sample liquid when the sensor chip 100 is used, and the first induction paths 14A, 14B and 14C via the filter 15. The introducing portion 13 is sealed before use, as shown in FIG. 1, and is opened for use by cleaving the sensor chip 100 at the portion indicated by the line C-C, so as to introduce the sample liquid. The filter 15 disposed between this introducing portion 13 and the first induction path 14C is for removing foreign substances contained in the sample liquid, and for a fiber filter or disk filter is appropriate for this purpose. If the sample liquid contains proteins, the filter 15 should preferably be a protein removal filter, in order to prevent an absorption reaction with the test reagent.

The induction paths 14A, 14B and 14C are for guiding the sample liquid, introduced from the introducing portion 13 to the sensor chip 100, to the reaction chambers 11A and 11B. In concrete terms, the first induction path has the induction path 14C which is connected to the introducing portion 13, and the induction path 14A and the induction path 14B which connect the induction path 14C to the reaction chamber 11A and reaction chamber 11B respectively. If the total length L1 of the induction path 14C and the induction path 14A, which connect the filter 15 and the reaction chamber 11A, is compared with the total length L2 of the induction path 14C and the induction path 14B which connect the filter 15 and the reaction chamber 11B, the total L2 is longer than the total L1. In other words, the length of the induction path, where the sample liquid introduced from the introducing portion 13 flows to each reaction chamber via the filter 15, is longer at the reaction chamber 11B side than the reaction chamber 11A side, therefore if the sample liquid feeding speed is the same in both induction paths, then the time to reach the reaction chamber 11B is longer than the time to reach the reaction chamber 11A.

The second induction paths 16A and 16B are connected respectively to the reaction chambers 11A and 11B. The induction path 16C, where the induction paths 16A and 16B merge, is also disposed. The induction paths 16A, 16B and 16C are used as induction paths to exhaust the sample liquid introduced to the reaction chambers 11A and 11B. In the cavity portion 17, which is connected to the induction path 16C, the sample liquid exhausted from the induction path 16C is stored. The suction port 18 and the insertion port 19 are also disposed via the filter 20 in order to connect the cavity portion 17 and outside the sensor chip 100. This filter 20 is a filter paper, for example, and has a function to prevent the sample liquid exhausted from the induction path 16C to the cavity portion 17 to be released to the outside.

Now a concrete method for introducing the sample liquid into the sensor chip 100 will be described. FIG. 3 is a diagram depicting a method for using the sensor chip 100 according to the present embodiment. First the top area of the introducing portion 13 of the sensor chip 100 is cleaved at the C-C line in FIG. 1, so as to open the introducing portion 13. Then the sample liquid is contacted to the opened introducing portion 13. Here a tip of a syringe 21 is inserted through the insertion port 19, and a suction operation is performed using a mobile piston or the like, then the cavity portion 17 reaches suction pressure, and as a result the sample liquid is introduced from the introducing portion 13 to the induction path 14C via the filter 15. The sample liquid is then branched from the induction path 14C to the induction paths 14A and 14B, and is introduced to the reaction chambers 11A and 11B. The sample liquid exhausted from the reaction chambers 11A and 11B by the suction pressure flow through the induction paths 16A and 16B and merge into the induction path 16C, and is exhausted into the cavity portion 17.

In this sensor chip 100, the cross-section area of the induction path 16C is smaller than the cross-section area of the induction path 14C. Therefore the suction pressure effect by the suction operation can be enhanced, and the sample liquid can be introduced more smoothly.

Now the test reagent that is carried by the fibrous materials 12A and 12B contained in the reaction chambers 11A and 11B of the sensor chip 100 will be described. For the test reagent carried in the fibrous materials 12A and 12B, a pH-indicator, coloring reagent and modification substance for measuring the fluorescent intensity of the sample liquid, for example, are used.

Examples of pH-indicators that can be appropriately used in the present embodiment are the pH-indicators 1 to 70 shown in Tables 1 to 4. In Tables 1 to 4, the absorption peak wavelength of the pH-indicator solution of each the pH-indicators 1 to 70 is shown as well.

TABLE 1

| | | Absorption |
|---|---|---|
| No. | Indicator Name | Wavelength |
| 1 | Basic Violet 1 | 585 nm |
| 2 | Crystal Violet | 595 nm |
| 3 | Metanil Yellow | 510 nm |
| 4 | Metacresol Purple | 510 nm |
| 5 | m-Cresol Purple Sodium Salt | 510 nm |
| 6 | p-Xylenol Blue | 510 nm |
| 7 | Thymol Blue | 510 nm |
| 8 | Thymol Blue Sodium Salt | 510 nm |
| 9 | Acid Orange 5 | 510 nm |
| 10 | Pentamethoxy Red | 560 nm |
| 11 | Benzopurpurine 4B | 585 nm |
| 12 | Basic Violet 1 | 590 nm |
| 13 | Benzyl Orange | 510 nm |
| 14 | 2,6-Dinitrophenol | 420 nm |
| 15 | 2,4-Dinitrophenol | 420 nm |
| 16 | Methyl Yellow | 510 nm |
| 17 | Tetrabromophenol Blue | 615 nm |
| 18 | Bromochlorophenol Blue | 585 nm |
| 19 | Bromophenol Blue | 590 nm |
| 20 | Bromophenol Blue Sodium Salt | 590 nm |

TABLE 2

| | | Absorption |
|---|---|---|
| No. | Indicator Name | Wavelength |
| 21 | Congo Red | 500 nm |
| 22 | Methyl Orange | 505 nm |
| 23 | Ethyl Orange | 510 nm |
| 24 | 4-Ethoxychrysoidine Hydrochloride | 510 nm |
| 25 | Bromocresol Green | 615 nm |
| 26 | Bromocresol Green Sodium Salt | 615 nm |
| 27 | 2,5-Dinitrophenol | 420 nm |
| 28 | Acid Red 2 | 510 nm |
| 29 | Methyl Red Sodium Salt | 525 nm |
| 30 | Lacmoid | 570 nm |
| 31 | TBPE | 585 nm |
| 32 | Chlorophenol Red | 510 nm |
| 33 | Chlorophenol Red Sodium Salt | 510 nm |
| 34 | 2-Nitrophenol | 420 nm |
| 35 | 2-Nitrophenol Sodium Salt | 420 nm |
| 36 | p-Nitrophenol | 420 nm |
| 37 | 4-Nitrophenol Sodium Salt | 420 nm |
| 38 | Bromocresol Purple | 590 nm |
| 39 | Bromocresol Purple Sodium Salt | 590 nm |
| 40 | Resazurin Sodium Salt | 605 nm |

TABLE 3

| | | Absorption |
|---|---|---|
| No. | Indicator Name | Wavelength |
| 41 | Bromophenol Red | 510 nm |
| 42 | Bromothymol Blue | 615 nm |
| 43 | Bromothymol Blue Sodium Salt | 615 nm |
| 44 | 3′,3″,5′,5″-Tetraiodophenolsulfonphthalein | 555 nm |
| 45 | Basic Red 5 | 510 nm |
| 46 | Phenol Red | 435 nm |
| 47 | Phenol Red Sodium Salt | 435 nm |
| 48 | Aurin | 555 nm |
| 49 | 3-Nitrophenol | 420 nm |
| 50 | Cyanine | 590 nm |
| 51 | alpha-Naphtholphthalein | 595 nm |
| 52 | Cresol Red | 555 nm |
| 53 | Cresol Red Sodium Salt | 555 nm |
| 54 | Curcumin (Natural) | 490 nm |
| 55 | Metacresol Purple | 580 nm |
| 56 | Bis(2,4-dinitrophenyl)acetic Acid Ethyl | 595 nm |
| | Ester | |
| 57 | Thymol Blue | 595 nm |
| 58 | Thymol Blue Sodium Salt | 595 nm |
| 59 | p-Xylenol Blue | 615 nm |
| 60 | o-Cresolphthalein | 555 nm |

TABLE 4

| | | Absorption |
|---|---|---|
| No. | Indicator Name | Wavelength |
| 61 | Phenolphthalein | 555 nm |
| 62 | Phenolphthalein Disodium Salt | 555 nm |
| | (Water soluble) | |
| 63 | p-Naphtholbenzein | 595 nm |
| 64 | Thymolphthalein | 595 nm |
| 65 | Mordant Orange 1 | 490 nm |
| 66 | Alizarin Yellow GG | 495 nm |
| 67 | Tropaeolin O | 435 nm |
| 68 | 1,3,5-Trinitrobenzene | 485 nm |
| 69 | Indigo Carmine | 595 nm |
| 70 | Litmus | 585 nm |

If the sample liquid is saliva, for example, a modification substance for measuring the coloring of the sample liquid can be used as the test indicator for measuring the concentration of bacteria selected from Streptococcus mutans (Sm), Streptococcus sobrinus (Ss) and Lactobacillus acidophilus (La), which are bacteria causing caries. More specifically, coloring reagents 71 to 78 shown in Table 5 are used as the coloring reagent. These coloring reagents 71 and 78 absorb light having a specific wavelength as the bonding with the bacteria causing caries contained in saliva, that is the sample liquid, progresses. Table 5 also shows the absorption peak wavelength of the solution in which each coloring reagent, 71 to 78, is dissolved.

TABLE 5

| No. | Coloring Reagent Name | Wavelength | |
|---|---|---|---|
| 71 | TMB (3,3′5,5′-tetramethylbendizine) | 655 (450) | nm |
| 72 | ABTS (2,2′-Azino-bis-(3-ethylbenziazoline-6- | 415 | nm |
| | sulfonic acid)) | | |
| 73 | BCIP (5-bromo-4-chloro-3-indoltl phosphate) | 595-650 | nm |
| 74 | p-NPP (p-nitrophenylphosphate) | 405 | nm |
| 75 | DTNB | 412 (405) | nm |
| 76 | Ellman reagent (5-thio-2-Nitrobezoic Acide) | 414 (405) | nm |
| 77 | Gold nano particle | 650 | nm |
| 78 | Gold colloid | 520 | nm |

For the test reagent, a modification substance for measuring the fluorescent intensity of the sample liquid can also be used. Examples of the modification substance that can be appropriately used for the present embodiment are modification substances 1 to 65 shown in Table 6 to Table 8. Table 6 is a table showing the modification substances 1 to 25, which are fluorescent reagents, Table 7 is a table showing the modification substances 26 to 44 constituted by fluorescent proteins, and Table 8 is a table showing the modification substances 45 to 68 which are reagents that strongly react with DNA/RNA and emit fluorescence. Tables 6 to 8 also show the maximum excitation wavelength and maximum fluorescent wavelength of each modification substance 1 to 68.

TABLE 6

| | | Maximum | Maximum |
|---|---|---|---|
| | | Excitation | Fluorescence |
| No. | Modification Substance Name | (nm) | (nm) |
| 1 | Fluorecein | 495 | 520 |
| 2 | PE | 488/545 | 580 |
| 3 | FITC (fluorescein isothiocyanate) | 495 | 520 |
| 4 | Cy2 | 489 | 505 |
| 5 | Cy3 | 550 | 570 |
| 6 | Cy3.5 | 581 | 596 |
| 7 | Cy5 | 650 | 670 |
| 8 | Cy5.5 | 678 | 703 |
| 9 | Hyper5 | 650 | 670 |
| 10 | Alexa Fluor 350 | 346 | 442 |
| 11 | Alexa Fluor 405 | 402 | 421 |
| 12 | Alexa Fluor 430 | 433 | 541 |
| 13 | Alexa Fluor 488 | 495 | 519 |
| 14 | Alexa Fluor 532 | 532 | 553 |
| 15 | Alexa Fluor 546 | 556 | 573 |
| 16 | Alexa Fluor 555 | 555 | 565 |
| 17 | Alexa Fluor 568 | 578 | 603 |
| 18 | Alexa Fluor 594 | 590 | 617 |
| 19 | Alexa Fluor 633 | 632 | 647 |
| 20 | Alexa Fluor 647 | 650 | 665 |
| 21 | Alexa Fluor 660 | 663 | 690 |
| 22 | Alexa Fluor 680 | 679 | 702 |
| 23 | Alexa Fluor 700 | 702 | 723 |
| 24 | Alexa Fluor 750 | 749 | 775 |
| 25 | Alexa Fluor 790 | 785 | 810 |

TABLE 7

| | | | Maximum |
|---|---|---|---|
| | | Maximum | Fluores- |
| | | Excitation | cence |
| No. | Modification Substance Name | (nm) | (nm) |
| 26 | CX-Rhodamine (5-carboxy-X-rhodamine) | 587 | 597 |
| 27 | TM-Rhodamine (Tetramethyl-rhodamine) | 559 | 576 |
| 28 | Rhodamine | 550 | 573 |
| 29 | RITE | 520 | 580 |
| 30 | Texas Red | 590 | 615 |
| 31 | TRITC | 543 | 580 |
| 32 | DAPI | 345 | 455 |
| 33 | AMCA | 350 | 450 |
| 34 | APC | 635 | 670 |
| 35 | FAM | 494 | 518 |
| 36 | HEX | 535 | 556 |
| 37 | TAMRA | 521 | 536 |
| 38 | TET | 555 | 580 |
| 39 | GFP | 488 | 460 |
| 40 | Enhanced green fluorescent protein | 489 | 508 |
| | (EGFP) | | |
| 41 | Enhanced blue fluorescent protein (EBFP) | 380 | 440 |
| 42 | Enhanced cyan fluorescent protein (ECFP) | 434 | 477 |
| 43 | Enhanced yellow fluorescent protein | 514 | 527 |
| | (EYFP) | | |
| 44 | DsRed | 558 | 583 |

TABLE 8

| | | Maximum | Maximum |
|---|---|---|---|
| | | Excitation | Fluorescence |
| No. | Modification Substance Name | (nm) | (nm) |
| 45 | Hoechst33342 | 343 | 483 |
| 46 | Chromomycin A3 | 442/457 | 575 |
| 47 | PI | 488/536 | 617 |
| 48 | YOYO-1 | 491 | 509 |
| 49 | CPO | 488 | 530/670 |
| 50 | Pyronin Y | 540 | 570 |
| 51 | 7-AAD | 546 | 647 |
| 52 | Ethidium homodimer-1 | 528 | 617 |
| 53 | SYTO9 | 483 | 500 |
| 54 | SYBR Green I | 498 | 522 |
| 55 | LDS751 | 543/590 | 712/607 |
| 56 | TO-PRO-3 | 642 | 661 |
| 57 | Acridine Orange (DNA) | 500 | 526 |
| 58 | Acridine Orange (RNA) | 460 | 650 |
| 59 | 7-ADD (7-Amino-Actinomycin D) | 546 | 647 |
| 60 | ACMA | 419 | 483 |
| 61 | DAPI | 358 | 461 |
| 62 | Ethidium Bromide | 518 | 605 |
| 63 | Hoechst 33258(bis-benzimide) | 352 | 461 |
| 64 | Hoechst 33342 | 350 | 461 |
| 65 | Hoechst 34580 | 392 | 498 |
| 66 | LDS 751 (DNA) | 543 | 712 |
| 67 | LDS 751 (RNA) | 590 | 607 |
| 68 | Propidium Iodide (PI) | 535 | 617 |

Different test reagents, out of the above indicators, are carried on the fibrous materials 12A and 12B of the sensor chip 100 according to the present embodiment. The type of test reagent and fibrous material that carries the reagent are determined based on the reaction time of the test reagent and the sample liquid. For example, out of the test reagents used for evaluation, an test reagent of which reaction time is relatively long (e.g. time from contact of the sample liquid and the test reagent to coloration is long) is carried by the fibrous material 12A contained in the reaction chamber 11A of the sensor chip 100, and an test reagent of which reaction time is short is carried by the fibrous material 12B contained in the reaction chamber 11B of the sensor chip 100, and suction is performed, then reaction of the sample liquid that flows into the reaction chamber 11A reaches the reaction chamber faster than the sample liquid that flows into the reaction chamber 11B, therefore the reaction can start more quickly. The sample liquid reaches the reaction chamber 11B, in which the test reagent of which reaction time is short is contained, more slowly. As a result, the reaction completion times in the reaction chambers 11A and 11B can be similar, and the reaction results in the reaction chamber 11A and reaction chamber 11B can be checked at the same time. Even in the case of using an test reagent which discolors quickly after reaction completes, the reaction result can be checked immediately after reaction completes, therefore the reaction result can be obtained at higher accuracy.

The sensor chip 100 having the above configuration can be created by sandwiching the frame materials 32 and 33, in which the cut C1 constituting the C-C line and the cut C2 constituting the insertion port 19 have been created, the fibrous materials 12A and 12B which are contained in the reaction chambers, and the filter 15 and the filter 20 by two sheet-type light transmitting films 31 and 34, and then fusing the edge portion by heat, as shown in FIG. 4. Thereby the outer package 10 is created by thermally fused film 31, frame material 32, frame material 33 and film 34, and the fibrous materials 12A and 1213 are contained in the containing portions 11A and 11B of the outer package 10, and the space created by the frame material 32 and frame material 33 becomes the first induction paths 14, second induction paths 16 and the cavity portion 17. The area enclosed by the filter 15 and the frame material 32 becomes the introducing portion 13. For the film 31 and film 34, a material not having light transmittance may be used, and a light transmitting material may be used for the areas to be the entrance portion and the reflection portion.

A variant form of the sensor chip 100 can also be created in the same manner as the sensor chip 101 shown in FIG. 5 by sandwiching the fibrous materials 12A and 12B to be contained in the reaction chambers, the filter 15 and the filter 20, by the sheet 41 where grooves 42, to be the first induction paths 14, second induction paths 16 and the cavity portion 17, have been formed, and the cut C1 and cut C2 have been created, and the sheet type film 43, and then fusing the edge portion by heat. In this case, the outer package 10 is created by the thermally fused sheet 41 and the film 43.

<Liquid Measurement Device>

A liquid measurement device 500 that can be appropriately used in the present embodiment will now be described.

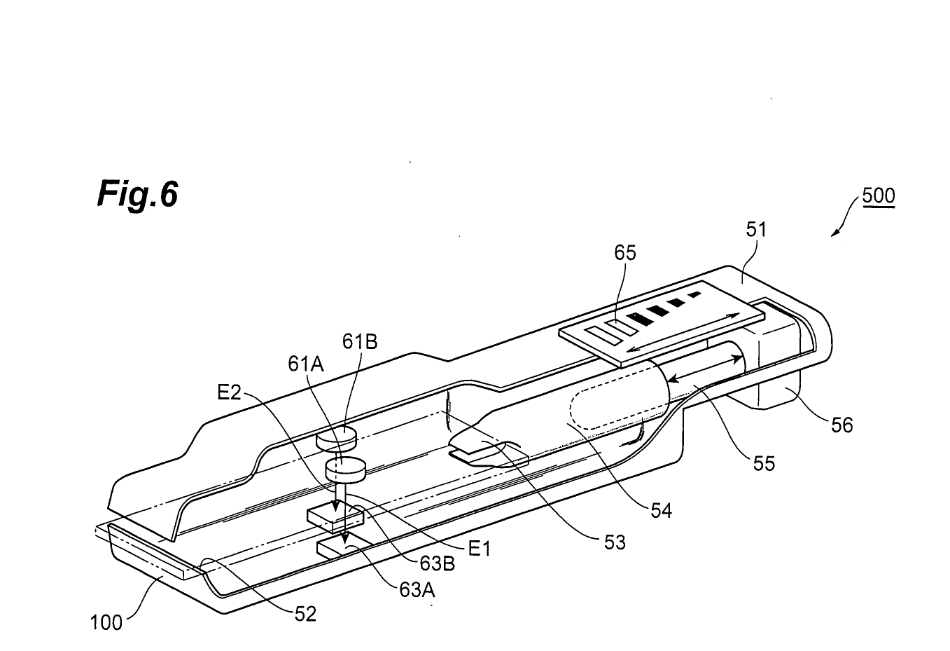

FIG. 6 is a diagram depicting a general configuration of the liquid measurement device 500 according to the first embodiment. As FIG. 6 shows, the liquid measurement device 500 has an enclosure 51, a housing portion 52 which is disposed inside the enclosure 51 and houses a sensor chip 100, in which sample liquid is held, in the longitudinal direction of the enclosure 51, a clip portion 53 which secures the sensor chip 100 housed in the housing portion 52 and encloses a suction mechanism to be connected to an insertion port 19 of the sensor chip 100, a cylindrical portion 54 which is a hollow cylinder constituting a pump mechanism, a cylindrical piston 55 which, along with the cylindrical portion 54, constitutes the pump mechanism by being inserted into the cylindrical portion 54, and a piston operation portion 56 for operating this piston 55. Inside the clip portion 53, a tip 57 of a syringe, which is not illustrated in FIG. 6, is disposed. The tip 57 of the syringe functions as a connection portion which is connected to the cavity portion 17 of the sensor chip 100 via the filter 20 and the suction port 18. The cylindrical portion 54 has a function corresponding to the syringe 21 in FIG. 3, and the piston 55 has a function corresponding to a mobile piston which performs a mobile suction operation. The cylindrical portion 54 and the piston 55 constituting the pump mechanism of the liquid measurement device 500 of the present embodiment are cylindrical shape, but the shape is not limited to this. The cylindrical portion 54 and the piston 55 may be a quadrangular prism, or may be a tubular element of which cross-section is elliptical.

Inside the liquid measurement device 500, a light source 61A which emits the light E1 including light having a predetermined wavelength, and a light source 61B which emits the light E2 are disposed. The liquid measurement device 500 further has a light receiving portion 63A which is disposed in a position facing the light source 61A, and has a sensitivity to the light E1 emitted from the light source 61A, and a light receiving portion 6313 which is disposed in a position facing the light source 61B and has a sensitivity to the light E2 emitted from the light source 61B. These light sources 61A and 61B and the light receiving portions 63A and 63B function as measurement portions.

The liquid measurement device 500 also has a control portion (not illustrated) to which the light sources 61A and 61B and the light receiving portions 63A and 63B are electrically connected. The control portion is constituted by a CPU (Central Processing Unit) and an external storage device, the CPU has a ROM (Read Only Memory) in which computing programs for performing predetermined operations are stored, and a RAM (Random Access Memory) for storing various data during computing processing. The CPU calculates an index value of the sample liquid based on the correlation (analytical curve) between the predetermined light transmittance of the test reagent, which is stored in the external storage device, and the index of the test reagent (e.g. pH, concentration of pathogenic bacteria) using the light transmittance of the test reagent that is calculated based on the intensity of the measured light which was output from the light sources 61A and 61B and the light intensity detected by the light receiving units 63A and 6313. The CPU has a function to perform this processing for each test reagent, and displays the evaluation based on the obtained result on an indicator 65.

Examples of the light source 12 are an LED (Light Emitting Diode), a semiconductor laser, an EL (Electro Luminescence) unit, a fluorescent lamp and a light bulb. In the case of the present embodiment, it is preferable to select a light source according to the absorption peak wavelength of the test reagent (maximum excitation wavelength if the test reagent is in a modification substance for fluorescence measurement) contained in the fibrous materials 12A and 12B of the sensor chip 100. In concrete terms, if a pH indicator shown in Tables 1 to 4 is used, the absorption peak wavelength may shift in a range of about ±100 nm depending on the dissolving state of the indicator, so it is preferable to confirm the absorption peak wavelength by a spectrophotometer, using a sensor chip 100 in a state where the pH indicator is soaked in the fibrous materials 12A and 12B or in a state where fibrous materials 12A and 12B, on which the pH indicator is absorbed, is contained in the outer package 10, and the light source to be used is set based on this wavelength. According to the present embodiment, it is preferable to use the light sources 61A and 61B that can emit light in the range of ±70 nm, or more preferably ±30 nm, of the absorption peak wavelength confirmed like this. For example, in the case of measuring the pH using a sensor chip 100 having a fibrous material 12A containing a p-Nitrophenol (pH discoloring range: (light yellow) 5.0 to 7.6 (yellow), absorption wavelength: 420 nm) as the pH indicator, the pH can be appropriately measured if the LED, which can emit light of which wavelength is in a 350 nm to 490 nm range, is used as the light source 61A, and it is preferable to use an LED that can emit light with a 428 nm wavelength (made by Rohm, product name: SML 010BA TT86) for the light source 61A, for example.

In the present embodiment, the wavelength of the light emitted from the light source 61A (61B) may be adjusted using an optical filter or the like. If an optical filter that can transmit light in a wavelength range used for measurement is disposed between the light source 61A and the sensor chip 100, and the light that transmitted through the optical filter, out of the light that is output from the light source 61A (61B), reaches the sensor chip 100, then the light source, that emits the light in a wavelength range including the wavelength range used for measurement, can be used as the light source 61A (61B) of the liquid measurement device 500. In this case, a white light source can be used as the light source 61A (61B), so the liquid measurement device 500 can be created with low cost. If the light quantity is sufficient for pH measurement, an external light may be used as the measurement light by adding a mechanism for condensing and introducing external light.

The light receiving portion 63A (63B), on the other hand, is required only to have sensitivity to light in the absorption wavelength area of the test reagent (fluorescent wavelength area if the test reagent is a fluorescent modification substance) contained in the fibrous material 12A (12B) of the sensor chip 100, and a photodiode, solar battery or photoelectric transfer element, for example, can be used.

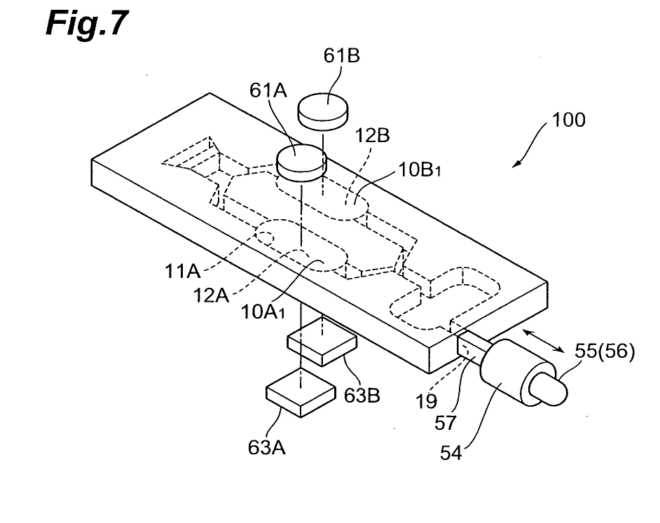

The light source 61A (61B) and the light receiving portion 63A (63B) are disposed so as to be at the height of the reaction chamber 11A (11B) where the fibrous material 12A (12B) is contained, when the sensor chip 100 is disposed in the housing portion 52, as shown in FIG. 7.

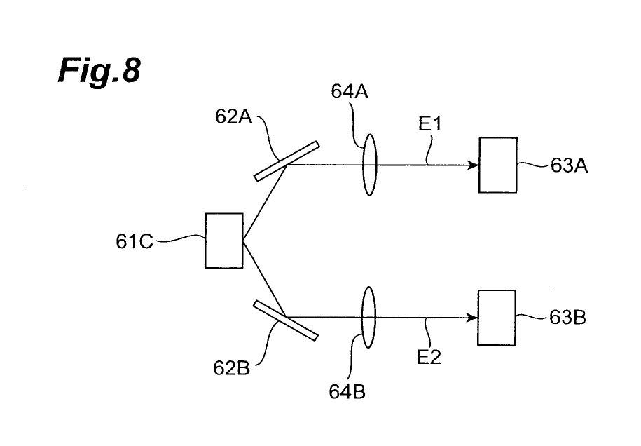

The light source and the light receiving portion need not always be disposed as a pair, but the light emitted from one light source 61C may be split into two lights, E1 and E2, using mirrors 62A and 62B and lenses 64A and 64B, so that these two lights E1 and E2 are irradiated onto the light receiving portions 63A and 63B respectively, as shown in FIG. 8.

<Measurement Method Using Liquid Measurement Device>

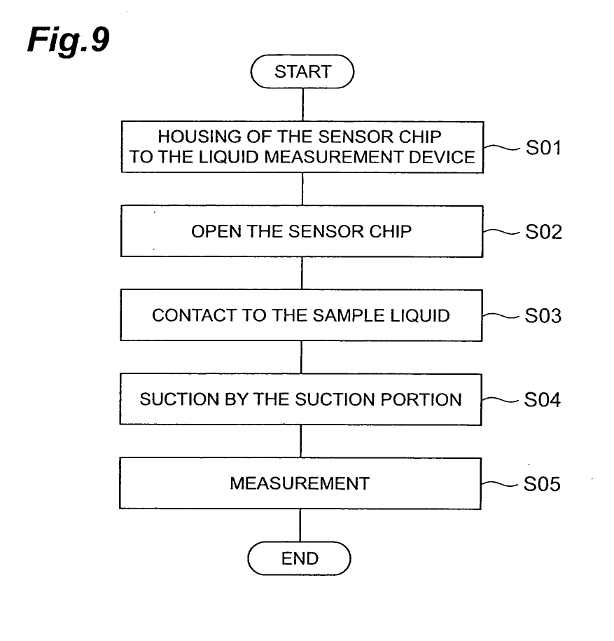

A method for measuring the sample liquid using the above mentioned liquid measurement device 500 and the sensor chip 100 will now be described with reference to FIG. 9.

First the sensor chip 100 is housed in the housing portion 52 of the liquid measurement device 500, so that the cavity portion 17 is held by the clip portion 53 (S01). By inserting the sensor chip 100 until it is correctly clipped by the clip portion 53, the reaction chamber 11A (11B) of the sensor chip 100 can be accurately housed between the light source 61A (61B) and the light receiving portion 63A (63B). Also by inserting until the sensor chip 100 is correctly clipped, the tip 57 of the syringe disposed inside the clip portion 53 is inserted into the insertion port 19 of the sensor chip 100 as shown in FIG. 7. At this time, the edge of the sensor chip 100 at the introducing portion 13 side is exposed to the outside from the housing portion 52. If the front face and rear face of the sensor chip 100 are reversed, the reaction chamber 11A (11B) cannot be positioned correctly between the light source 61A (61B) and the light receiving portion 63A (63B). Therefore a slit is cut in the sensor chip 100, so that the sensor chip 100 cannot be deeply inserted into the housing portion 52 if the insertion direction to the housing portion 52 is incorrect. The front face and rear face may be distinguished by adding an indication to distinguish the front face and the rear face in an area of the outer package 10, excluding the entrance portion and reflection portion, or by coloring the outer package 10 to a degree not to drop the transmittance of the outer package 10 considerably.

Then the edge of the sensor chip 100 exposed outside the housing portion 52 is opened along the C-C line in FIG. 1 (S02). Thereby the introducing portion 13 is exposed to the outside.

Then the sample liquid is contacted to the introducing portion 13 exposed to the outside (S03). The sample liquid that is measured using the liquid measurement device 500 and the sensor chip 100 according to the present embodiment is preferably a solution of which viscosity is 10 P (1 Pa·S) or less, in terms of water absorbency.

Then the piston operation portion 56 is operated in a state of the sample liquid contacting the introducing portion 13, whereby the piston 55 is moved to perform suction (S04). By this, the sample liquid is introduced from the introducing portion 13 into the sensor chip 100, and the sample liquid is introduced into the housing portions 11A and 11B sequentially via the first induction path, the test reagents carried by the fibrous materials 12A and 12B and the sample liquid are sequentially contacted, where the reaction is started. When the reaction completes, light is irradiated from the light source 61A (61B) to the reaction chamber 11A (11B) via the entrance portion 10A₁ (10B₁) of the outer package 10, and the transmitted light emitted from the sensor chip 100 via the emission portion 10A₂ (10B₂) of the outer package 10 is received by the light receiving portion 63A (63B), and the light transmittance of the sample liquid which reacted with each test reagent is measured (S05). In this case, the sample liquid adhered to the fibrous material 12A (12B) in the housing unit 11A (11B) is held by the space created by the fibers contained in the fibrous material 12A (12B), where micro cells are created. Thereby light that transmits through the sample liquid held between the fibrous materials 12A and 12B can be increased.

If a modification material for fluorescent measurement is used as the test reagent, the fluorescent intensity emitted from the sample liquid is measured by the light irradiated from the light source 61A (61B) in the light receiving portion 63A (63B) reacting with the test reagent in the reaction chamber 11A (11B). In the case of measuring the fluorescent intensity as well, the fluorescence emitted from the sample liquid can reach the light receiving portion 63A (63B) more easily because of the above mentioned micro cells that are created, therefore the fluorescent intensity can be measured more accurately.

Before the light transmittance of the sensor chip 100, in which the sample liquid adheres, is measured, zero point correction is performed. For the zero point correction, two samples of which light transmittances are known are measured, and the gain and offset are adjusted based on the acquired result, or the light intensity of the light source is measured in the dark state, and offset is corrected, for example. In the liquid measurement device 500 according to the present embodiment, zero point correction is performed before housing the sensor chip 100 in the housing unit 52.

Now the measurement using the sensor chip 100 completes. In the case of measuring light transmittance, light intensity irradiated from the light source 61A (61B) and light intensity received by the light receiving portion 63A (63B) are sent to the control portion respectively, and the control portion calculates the light transmittance of the sensor chip 100. From the result, the index value of the sample liquid can be calculated based on the correlation (analytical curve) between the light transmittance and index value (e.g. pH, bacteria concentration) for the sensor chip 100, which have been stored in the external storage device. Using this result, the control unit evaluates and displays the evaluation result on the indicator 65 if necessary. The sensor chip 100 after use can easily be removed from the liquid measurement device 500, by pulling the sensor chip 100 out from the clip portion 53. The sensor chip 100 once used is not used again.

### Effect of this Embodiment

According to the solution measurement method using the sensor chip 100 and the liquid measurement device 500, the piston 55 is inserted into the insertion port 19 of the sensor chip 100, and is sucked. Thereby the sample liquid is introduced by the introducing portion 13, and is sent to the reaction chambers 11A and 11B where the test reagent is kept, via the first induction paths 14A, 14B and 14C, and the test reagent and the sample liquid react in these reaction chambers 11A and 11B. Since the length of each induction path connecting the introducing portion 13, for introducing the sample liquid, and the reaction chamber 11A and 11B in which the test reagent is held, is different from each other, the times required for the sample liquid introduced by the introducing portion 13 to reach the reaction chambers 11A and 11B differ respectively. Therefore when measurement is performed using test reagents of which reaction times are different from each other, the test reagent of which reaction time is longer is held in the reaction chamber 11A of which length of the first induction path is short, and the test reagent of which reaction time is shorter is held in the reaction chamber 11B of which length of the first induction path is long, whereby the time when the reaction between the sample liquid and each test reagent completes can be closer. As a result, the reaction results by a plurality of types of test reagents can be checked all at once, and the sample liquid can be evaluated more easily and accurately.

In the sensor chip 100 of the present embodiment, the introducing portion 13 is sealed by the outer package 10 and is opened for use, so the test reagents held in the reaction chambers 11A and 11B in the outer package 10 can be prevented from deteriorating by contacting the outside air, and the sample liquid can be evaluated more accurately.

In the reaction chambers 11A and 11B of the sensor chip 100 of the present embodiment, the fibrous materials 12A and 12B are contained in the reaction chambers 11A and 11B in the state of the outer package 10 sandwiching the fibrous materials 12A and 12B from both sides thereof. By this configuration, micro spaces are created by the fibers contained in the fibrous materials 12A and 12B, and the micro cells are created by the sample liquid being held by these micro spaces, and light that transmits through the reaction chambers containing the fiber can be increased via these micro cells, and as a result, evaluation of the sample liquid using the optical system can be performed more accurately. Furthermore, according to the sensor chip 100 of the present embodiment, the test reagents in the reaction chambers 11A and 11B are carried by the fibrous materials 12A and 12B, and micro cells are created by the sample liquid being held by the fibrous materials 12A and 12B. Since the test reagent and the sample liquid are appropriately dispersed and reacted in these micro cells, the measurement result dispersion depending on the measurement location is decreased, and the sample liquid can be evaluated at higher accuracy.

In the sensor chip 100 according to the present embodiment, the induction paths 16A and 16B, which are the second induction paths, merge at the area above the cavity portion 17. Since the induction paths 16A and 16B merge in an area between the reaction chambers 11A and 11B and the cavity portion 17, suction pressure in the induction paths 16A and 16B, when suction is performed by the piston 55, can be equalized. As a result, the completion time of reaction in the reaction chambers 11A and 11B can be adjusted more accurately.

### Second Embodiment

### Sensor Chip

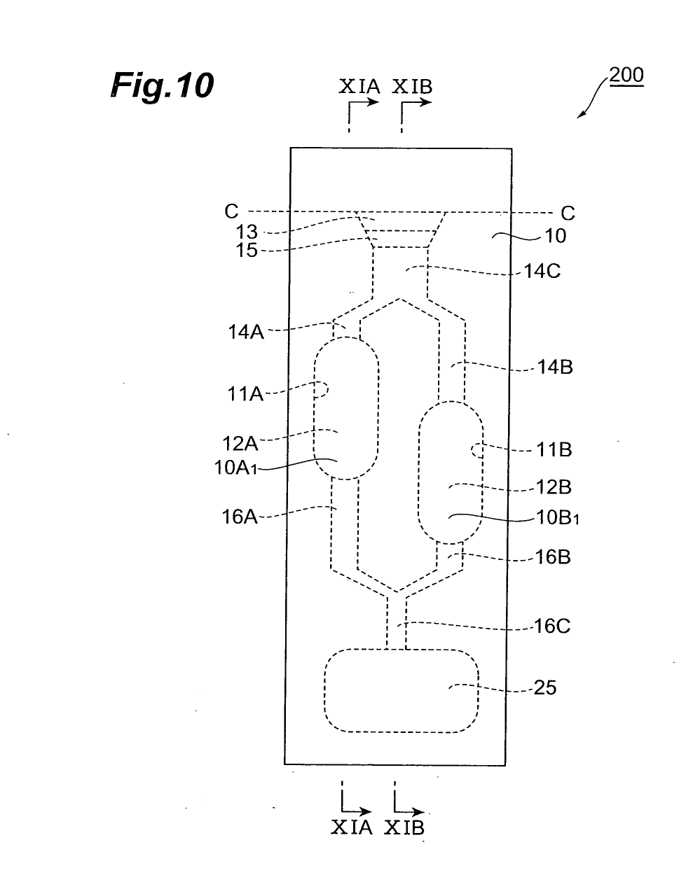

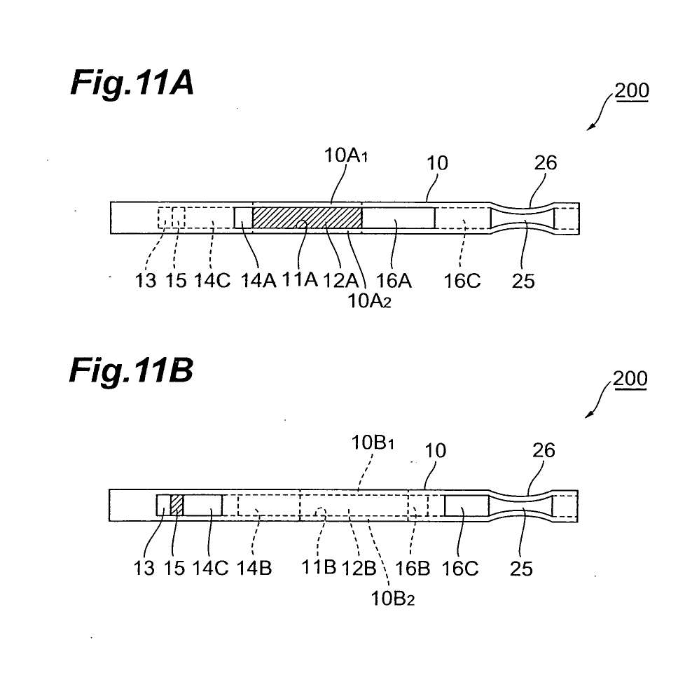

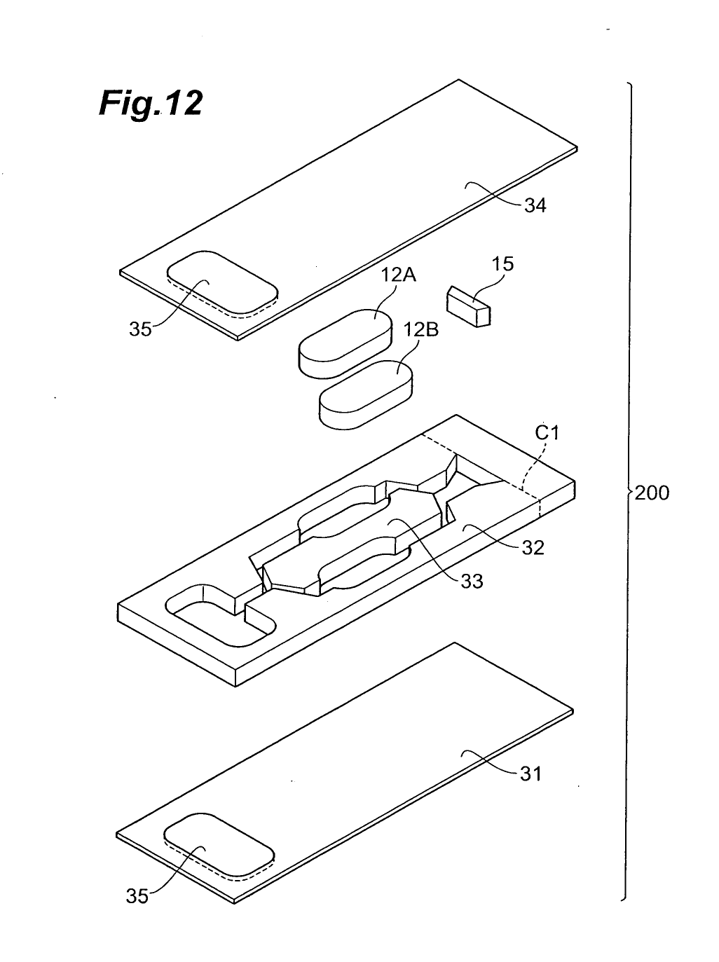

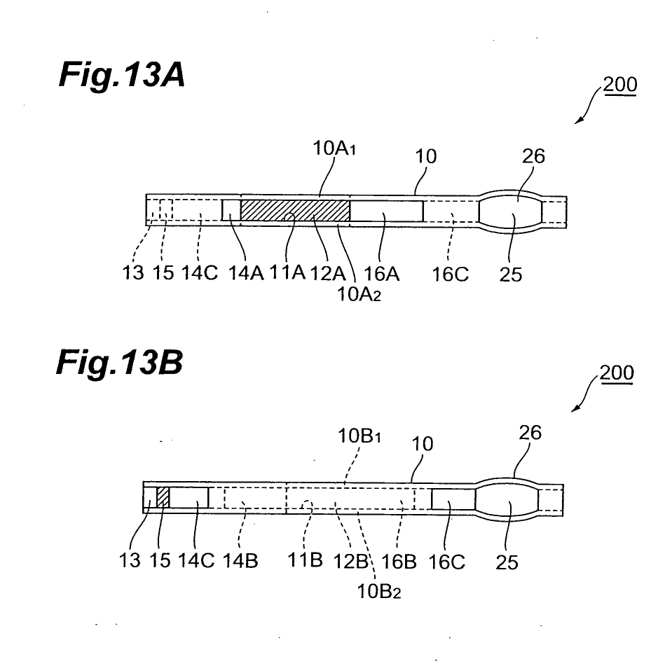

FIG. 10 is a front view depicting a sensor chip 200 according to a second embodiment of the present invention, FIG. 11A is a cross-sectional view of XIA-XIA in FIG. 10, FIG. 11B is a cross-sectional view of XIB-XIB in FIG. 10, and FIG. 12 in an exploded perspective view of FIG. 10. FIGS. 13A, 13B are diagrams depicting a method for using the sensor chip 200. The sensor chip according to the second embodiment of the present invention will now be described with reference to these drawings.

A difference of the sensor chip 200 according to the present embodiment from the sensor chip 100 according to the first embodiment is as follows. That is, a cavity portion 25 is sealed in the outer package 10, and the sample liquid contacting the introducing portion 13 is sucked by increasing the volume of this cavity portion 25. The sensor chip 200 will now be described focusing on this difference of configuration.

The cavity portion 25 is connected to the induction path 16C, just like the cavity portion 17 of the sensor chip 100, and the center portion thereof concaves toward the inside direction of the sensor chip 200 before use (before opening). This shape is created by slacking the films 26 which are disposed sandwiching the cavity portion 25 of the sensor chip 200. For this film 26, highly flexible material, such as PET film, for example, is most appropriate.

As FIG. 12 shows, the sensor chip 200 having the above configuration can be created by sandwiching frame materials 32 and 33, fibrous materials 12A and 12B which are contained in the reaction chambers, and the filter 15 by two sheet type films 31 and 34, on which a highly flexible film 35 to be a film 26 constituting the cavity portion 25 is disposed respectively at a position where the cavity portion 25 is located, and then fusing the edge portion by heat such that the film 35 concaves in an inside direction of the sensor chip 200. Thereby the fibrous materials 12A and 12B are contained in the housing portions 11A and 11B of the outer package 10, and the space formed by the frame material 32 and the frame material 33 become the first induction paths 14 (14A to 14C) and the second induction paths 16 (16A to 16C). The area enclosed by the filter 15 and the frame material 32 become the introducing portion 13. The area enclosed by the highly flexible film 35 and the frame material 32 becomes the cavity portion 25.

Another configuration of the sensor chip 200 is that only one of the two sheet type films constituting the sensor chip 200 is a highly flexible film. Or just like the sensor chip 101 in FIG. 5, the sensor chip 200 may be created, by sandwiching the fibrous materials 12A and 12B to be contained in the reaction chambers, the filter 15 and filter 20 by a sheet where grooves to be the first induction paths 14, second induction paths 16 and cavity portion 25 have been formed, and a highly flexibly sheet type film, and then fusing the edge portion by heat while pressing such that film at the position to sandwich the cavity portion 25 concaves in the inside direction of the sensor chip 200.

Now a concrete method for introducing the sample liquid into the sensor chip 200 having the above configuration will be described. The sensor chip 200 introduces the sample liquid inside by increasing the volume of the cavity portion 25 so as to generate suction pressure inside the induction paths 14A to 14C and the induction paths 16A to 16C. FIGS. 13A, 13B are cross-sectional views depicting the state when the volume of the cavity portion 25 of the sensor chip 200, shown in FIGS. 11A and 11B, is increased. In the sensor chip 200 shown in FIGS. 13A and 13B, the top area of the introducing portion 13 is cleaved at the C-C line in FIG. 10. As FIGS. 13A and 13B show, if the film 26 sandwiching the cavity portion 25 spreads in a direction protruding toward outside the sensor chip 200, the volume of the cavity portion 25 is increased, and thereby the pressure inside the outer package 10 is decreased. If the introducing portion 13 is contacting the sample liquid at this time, the sample liquid is introduced into the sensor chip 200 from the introducing portion 13 by this suction pressure inside. Then the sample liquid is introduced via the filter 15 from the induction path C, branched into the induction paths 14A and 14B, and introduced into the reaction chambers 11A and 11B, where reaction with the test reagents held in the reaction chambers 11A and 11B is started. The sample liquid exhausted from the reaction chambers 11A and 11B by the suction pressure merge in the induction path 16C by way of the induction paths 16A and 16B, and is exhausted to the cavity portion 25.

<Liquid Measurement Device and Measurement Method Using this Device>

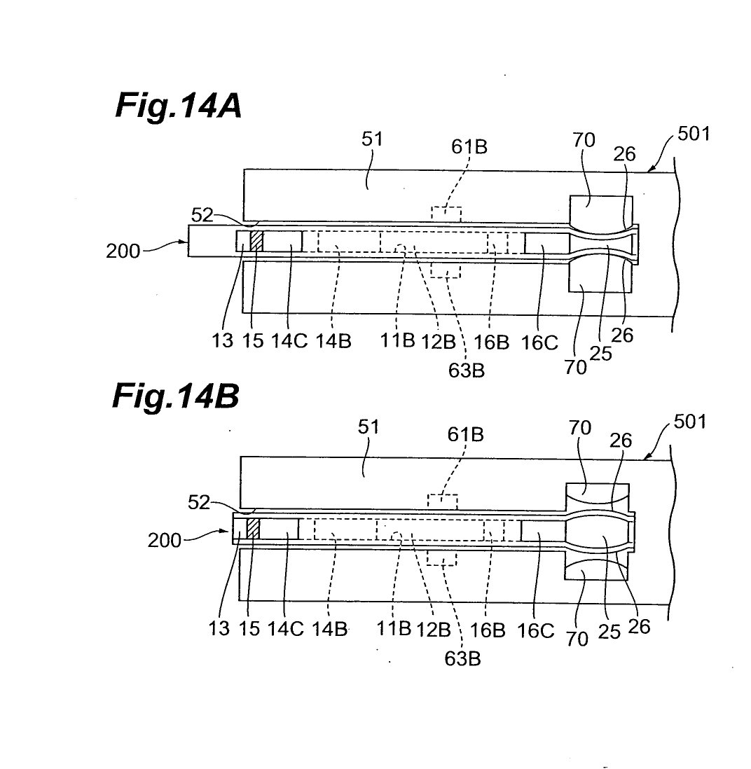

A liquid measurement device 501 that can be appropriately used in the present embodiment will now be described. A difference of the liquid measurement device 501 according to the present embodiment from the liquid measurement device 500 is as follows. That is, the liquid measurement device 501, has a pressing portion (pressing body) 70 for holding the cavity portion 25 of the sensor chip 200, instead of the chip portion 53 that is disposed inside the housing portion 52 for housing the sensor chip 200, so as to include the tip 57 of the syringe inside. This configuration will be described with reference to FIGS. 14A, 14B.

FIGS. 14A, 14B are cross-sectional views depicting a part of a configuration of the liquid measurement device 501, for describing the state when the sensor chip 200 is housed in the housing portion 52 of the liquid measurement device 501. FIG. 14A shows a state when the sensor chip 200 is housed in the liquid measurement device 501 before use, and FIG. 14B shows operation of the liquid measurement device 501 when the sample liquid is introduced into the sensor chip 200.

As FIG. 14A shows, after the sensor chip 200 is housed in the housing portion, the pressing portion 70 disposed in the enclosure 51 of the liquid measurement device 501 protrudes to inside of the housing portion 52 from the enclosure before use, so that the film 26 of the sensor chip 200 is supported in a state where the film 26 of the sensor chip 200 housed inside the housing portion 52 is pressed by the pressing portion 70. Then as FIG. 14B shows, the top area (left side in FIG. 14B) of the introducing portion 13 of the sensor chip 200 is unsealed so that the sample liquid contacts this location, and the pressing portion 70 is moved in the vertical direction so as to release the pressure to press the film 26 by the pressing portion 70, whereby the volume of the cavity portion 25 increases. By this, the suction pressure is generated inside the sensor chip 200, and the sample liquid contacting the introducing portion 13 is introduced into the sensor chip 200. After the sample liquid is introduced into the reaction chambers 11A and 11B and a predetermined time has elapsed, the light sources 61A and 61B irradiate lights having predetermined wavelengths, and the light receiving portions 63A and 63B receive the lights, then the light transmittance by the sample liquid, which reacted with each test reagent, is measured.

The measurement method using the liquid measurement device 501 will be described with reference to FIG. 9. First the sensor chip 200 is housed in the housing portion 52 of the liquid measurement device 501 so that the cavity portion 25 is supported by the pressing portion 70 (S01). To insert the sensor chip 200 at this time, the pressing portion 70 is housed in the enclosure 51, and is moved after the sensor chip 200 is inserted so as to protrude toward the inside from the enclosure 51, then the pressing portion 70 can correctly press the film 26 constituting the cavity portion 25, and the reaction chamber 11A (11B) of the sensor chip 200 can be accurately housed between the light source 61A (61B) and the light receiving portion 63A (63B).

Then the edge of the sensor chip 200 exposed to the outside from the housing portion 52 is opened along the C-C line in FIG. 10 (S02). Thereby the introducing portion 13 is exposed to the outside.

Then the sample liquid is contacted with the exposed introducing portion 13 (S03). In the state of the sample liquid contacting the introducing portion 13, the pressing portion 70 is moved up and down, thereby the volume of the cavity portion 25 is increased, and suction is performed (S04). By this, the sample liquid is introduced from the introducing portion 13 into the sensor chip 200, and the sample liquid is introduced into the housing portions 11A and 11B sequentially via the first induction paths, and the test reagents carried by the fibrous materials 12A and 12B and the sample liquid sequentially contact, and reaction starts. When the reaction completes, the light source 61A and 61B irradiate lights to the reaction chambers 11A and 11B via the entrance portions 10A₁ and 10B₁ of the outer package 10, the transmitted lights emitted from the sensor chip 100 via the emission portions 10A₂ and 10B₂ of the outer package 10 are received by the receiving portions 63A and 63B, and the light transmittance of the sample liquid reacted with each test reagent is measured (S05). At this time, the sample liquid adhered to the fibrous materials 12A and 12B in the housing portions 11A and 11B are held in the spaces created by the fibers included in the fibrous materials 12A and 12B, and micro cells are created. The measurement using the sensor chip 200 is thus completed. In the case of measuring light transmittance, the light intensity irradiated from the light source 61A (61B) and the light intensity received by the light receiving portion 63A (63B) is sent to the control portion, where the light transmittance of the sample liquid to each test reagent is calculated, and evaluation is performed using this result.

### Effect by this Embodiments

In the case of the solution measurement method using the above mentioned sensor chip 200 and the liquid measurement device 501 as well, just like the solution measurement method using the sensor chip 100 and the liquid measurement device 500, the lengths of the induction paths connecting the introducing portion 13 for introducing the sample liquid and the reaction chambers 11A and 11B holding the test reagents are different from each other, and therefore the times required for the sample liquid introduced from the introducing portion 13 to reach the reaction chambers 11A and 11B are different from each other, hence if the arrangement of the test reagents is changed according to the respective length of the reaction time, then the reaction results by a plurality of test reagents can be checked all at once, and the sample liquid can be evaluated more easily and more accurately.

(Variant Forms)

Embodiments of the present invention were described above, but the sensor chip and the liquid measurement device according to the present invention can be modified in various ways. These variant forms will now be described.

In the sensor chips according to the above embodiments, the fibrous materials 12A and 12B are held only in the housing portions 11A and 11B, but the fibrous materials may also be held in the induction paths 14A to 14C and induction paths 16A to 16C as well, so that the sample liquid is introduced from the introducing portion 13 to the reaction chambers 11A and 11B using suction by the suction portion and capillaries by the fibrous material. In this case, if the fibrous material not carrying the test reagents is held in the induction paths 14A to 14C, the risk of the test reagents dissolving into the sample liquid can be decreased. The fibrous material may be disposed only in one of the induction paths 14A to 14C and the induction paths 16A to 16C.

In the sensor chips according to the above embodiments, the induction paths 14A and 14B and induction paths 16A and 16B, directly connected to the reaction chambers 11A and 11B, have the same cross-section area, but these cross-section areas can be changed. The cross-section areas of these induction paths can be appropriately selected according to the viscosity of the sample liquid and the types of the test reagents being held in the reaction chambers.

In the above embodiments, the sensor chips having two reaction chambers 11A and 11B were described, but the number of reaction chambers may be three or more. In the case of three or more reaction chambers, the lengths of the first induction paths for introducing the sample liquid into different reaction chambers are set to be different, and different test reagents are held in the plurality of reaction chambers according to the length of each first induction path, then the time when the reaction between the sample liquid and the test reagents completes in each reaction chamber can be closer, so the measurement results on three or more test reagents can be checked all at once.

In the liquid measurement devices according to the above embodiments, one light source and one light receiving portion are disposed for one reaction chamber of the sensor chip, but a plurality of light sources and light receiving portions may be disposed for one reaction chamber. In the case of this configuration, lights having a plurality of wavelengths can be irradiated onto the test reagents held in one reaction chamber for measurement, so measurement accuracy can be improved. If a plurality of lights having a same wavelength is irradiated onto the test reagents held in one reaction chamber for measurement, the generation of measurement result dispersion due to the dispersion of test reagents or sample liquid in the reaction chamber can be suppressed, and therefore measurement accuracy can be improved.

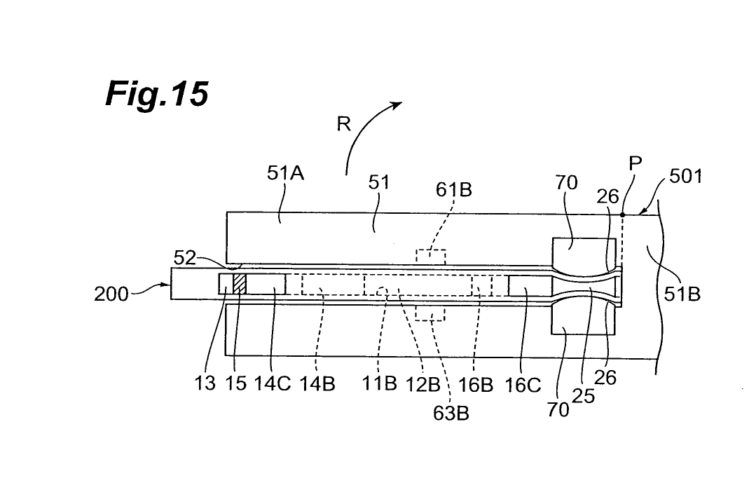

In the liquid measurement devices according to the above embodiment, a method for housing the sensor chip in the liquid measurement device described above was to insert the sensor chip into the housing portions disposed in locations where the light source and the light receiving portions have been disposed in the areas corresponding to the reaction chambers of the sensor chip, but the sensor chip may be housed in the housing portion by other methods. For example, as FIG. 15 shows, the element 51A at the light source 61B side, out of the enclosure 51 holding the sensor chip, is constructed to be rotatable around the supporting point P, and the element 51A is rotated in the direction R shown in FIG. 15, with respect to the element 518 at the light receiver 63B side out of the enclosure 51, so that the housing portion is opened and the sensor chip is positioned, and then the element 51A is rotated back to the position shown in FIG. 15, thereby the state in which the sensor chip is housed in the housing portion 52 and is ready for measurement is established.

In the liquid measurement devices according to the above embodiments, the configuration is for measuring the light transmittance when the light source and the light receiving portion face each other with the reaction chambers there between, but the positions of the light source and light receiving portion with respect to the reaction chambers can be appropriately changed. For example, in order to measure the light reflectance of the sample liquid, the light source and the light receiving portion may be disposed next to each other on the surface of one side of the sensor chip. In this case, a sensor chip, in which the entering portion disposed in an area contacting the reaction chamber of the outer package also functions as the emission portion, and is disposed on one face corresponding to the positions of the light source and light receiving portion, is used for liquid measurement.

What is claimed is:

1. A sensor chip, comprising:
an outer package;
a plurality of reaction chambers disposed inside the outer package;
a plurality of first induction paths that are connected to the plurality of reaction chambers and introduce a sample liquid into the plurality of reaction chambers respectively;
an introducing portion that is connected to the first induction paths and introduces the sample liquid into the first induction paths;
a plurality of second induction paths that are connected to the plurality of reaction chambers respectively; and
a suction portion that is connected to the plurality of second induction paths and sucks the sample liquid flowing in the plurality of second induction paths,
wherein the outer package has a light transmitting entrance portion for light to enter into the reaction chambers, and a light transmitting emission portion for light to emit from the reaction chambers,
the plurality of first induction paths have different lengths from one another, and
different types of test reagents are held in the plurality of reaction chambers respectively.

2. The sensor chip according to claim 1, wherein cross-section areas of the first induction paths are different from one another.

3. The sensor chip according to claim 1, wherein the introducing portion is sealed by the outer package, and is opened for use.

4. The sensor chip according to claim 1, wherein a sheet type fibrous material is filled in the plurality of reaction chambers.

5. The sensor chip according to claim 4, wherein the test reagent is carried by the fibrous material.

6. The sensor chip according to claim 1, wherein the plurality of second induction paths merge with one another between the plurality of reaction chambers and the suction portion.

7. The sensor chip according to claim 1, wherein the suction portion has a space sealed by the outer package, and sucks the sample liquid by increasing the volume of the space during use.

8. The sensor chip according to claim 1, wherein the suction portion comprises a pump mechanism, and sucks the sample liquid by the pump mechanism operating during use.

9. The sensor chip according to claim 1, wherein a cross-section area of the second induction path that is connected to one reaction chamber included in the plurality of reaction chambers is smaller than a cross-section area of the first induction path that is connected to the one reaction chamber.

10. A method for using a sensor chip which has: an outer package; a plurality of reaction chambers disposed inside the outer package; a plurality of first induction paths that are connected to the plurality of reaction chambers and introduce a sample liquid into the plurality of reaction chambers respectively; an introducing portion that is connected to the first induction paths and introduces the sample liquid into the first induction paths; a plurality of second induction paths that are connected to the plurality of reaction chambers respectively; and a suction portion that is connected to the plurality of second induction paths and sucks the sample liquid flowing in the plurality of second induction paths, the outer package having a light transmitting entrance portion for light to enter into the reaction chambers, and a light transmitting emission portion for light to emit from the reaction chambers,
the method comprising introducing the sample liquid into the plurality of reaction chambers by opening the introducing portion of the outer package for the sample liquid to contact the introducing portion and by sucking the sample liquid using the suction portion, to thereby react the sample liquid and the test reagent,
wherein a time from the sample liquid contacting the introducing portion to the sample liquid being introduced into the reaction chamber is different for each of the plurality of reaction chambers.
